(19) United States
(12) Patent Application Publication
(10) Pub. No.: US 2009/0239398 A1
(43) Pub. Date: Sep. 24, 2009

(54) PRESS FIT (COMPLIANT) TERMINAL AND OTHER CONNECTORS WITH TIN-SILVER COMPOUND

(75) Inventors: Joseph J. Lynch, East Northport, NY (US); Richard Schneider, Livonia, MI (US)

Correspondence Address: DARBY & DARBY P.C., P.O. BOX 770, Church Street Station, New York, NY, 10008-0770, US

(73) Assignee: Interplex NAS, Inc., College Point, NY (US)

(21) Appl. No.: 12/407,921

(22) Filed: Mar. 20, 2009

Related U.S. Application Data
(60) Provisional application No. 61/038,159, filed on Mar. 20, 2008.

(51) Int. Cl. H01R 12/00; H01R 43/00

(52) U.S. Cl. 439/81; 29/855

(57) ABSTRACT

A tin-silver press-fit interconnect which includes a press-fit terminal having a coating or finish of a tin-silver compound for use with a terminal receiving device. The tin-silver compound serves to prevent the formation of tin whiskers which appear most frequently in pure tin coated electrical components under mechanical stress and which make the electronic device susceptible to short circuits. The tin-silver compound may include between 85 and 99.5% weight of tin and between 0.5 and 15% weight of silver and is applied at a thickness range between 0.4 and 5 microns using a technique such as electroplating, hot dip or immersion.

### CROSS-REFERENCE TO RELATED APPLICATION

The present application claims the benefit of U.S. Provisional Patent Application Ser. No. 61/038,159, filed Mar. 20, 2008, which is hereby incorporated by reference in its entirety.

### FIELD OF THE INVENTION

The present invention generally relates to electrical connectors, and more specifically to press-fit terminals having a tin-silver coating.

### BACKGROUND OF THE INVENTION

As part of a shift towards a cleaner, safer environment, the electronics industry has been eliminating the use of lead as a doping agent in tin component coatings, as well as in soldering materials and operations. These tin-lead compounds were used to create a coating or soldering material with a particular melting temperature by varying the relative amounts of tin and lead in the compound. For example, a tin-lead compound having 63% tin and 37% lead is eutectic, meaning that it has the lowest possible melting point for the mixture of the two components, melting at 183° C. By varying the relative amounts of lead and tin, the melt temperature could be raised to a higher melting temperature as needed by the application. Nevertheless, despite this versatility, a call for a cleaner environment has led to the elimination of the use of lead as a doping agent.

Many problems have arisen in finding a suitable replacement, leading most manufacturers to use pure tin as a coating material for electrical components and for soldering those components to printed circuit boards (“PCBs”). Two main problems have arisen with the emergence of pure tin coatings. First, the inability to raise and vary the melt temperature has decreased the cycle life and effectiveness of such electrical components in higher temperature applications. Second, pure tin coatings have a tendency to produce whisker growth. Tin whiskers are electrically conductive, crystalline structures of tin that grow from electrical components coated with a pure tin finish. These thin strands of tin have been observed to grow to lengths up to 10 mm. Thus, a PCB having closely spaced circuit elements coated with a tin finish is susceptible to short circuit failure caused by tin whiskers bridging gaps between electrical components.

Tin whiskers are particularly problematic when using solderless electrical components. Solderless electrical components rely on mechanical forces, rather than solder, for retention in a PCB. The stress on the coated electrical components caused by these mechanical forces promotes the growth of tin whiskers and thus perpetuates the problems associated therewith.

Many industries have been turning to the use of solderless components to reduce material costs and production steps. Further, the industries are demanding that such components be able to operate under a variety of harsher conditions, such as at higher temperatures and vibration. Thus, what is needed is a solderless component that can operate under these conditions without the problems associated with the growth of tin whiskers.

### SUMMARY OF THE INVENTION

The present invention is directed to a tin-silver press-fit interconnect which includes a press-fit terminal having a coating or finish of a tin-silver compound for use with a plated through-hole, typically located in a PCB. In one embodiment, the terminal includes two beams which converge at a tip located at the bottom of the terminal. A generally oval-shaped aperture, or needle-eye, is located between the two beams. The diameter of the plated through-hole is less than the maximum width of the terminal as measured between the outer peripheral edges of the two beams. To assemble the press-fit interconnect, the tip of the terminal is pressed through the plated through-hole. As the terminal continues to be pushed into the plated through-hole, the outer edges of the beams engage the walls of the plated through-hole and begin to converge toward each other, thereby narrowing the needle-eye. A normal force caused by the beams pressing outwardly on the walls of the plated through-hole operates to hold the terminal within the plated through-hole and maintain the electrical connection.

The tin-silver compound that is provided as a coating on the terminal serves to prevent the formation of tin whiskers which appear most frequently in pure tin coated electrical components under mechanical stress. Tin whiskers have been known to grow to lengths of tip to 10 mm, thereby increasing the risk of a short circuit caused by the tin whisker bridging the gap between electrical components. Preferably, the tin-silver compound includes between 85 and 99.5% weight of tin and between 0.5 and 15% weight of silver and is applied at a thickness range between 0.4 and 5 microns using a technique such as electroplating, hot dip or immersion. The relative proportion of tin and silver may be modified to thereby modify the temperature characteristics, such as melt temperature, to suit particular applications, such as high temperature applications.

The resulting tin-silver interface provides a harder surface having a lower coefficient of friction such that there is less friction and lower assembly forces during assembly or insertion. Further, the tin-silver coating results in less fretting corrosion than pure tin. Fretting corrosion is a phenomenon which results from microscopic relative motion of interconnecting parts. As a result of these small movements, the oxides near the contact points can be broken up, with fresh material being exposed to the atmosphere, resulting in oxidized wear debris in the contact area, which ultimately leads to an increase in contact resistance.

### BRIEF DESCRIPTION OF THE DRAWINGS

The foregoing and other features of the present invention will be more readily apparent from the following detailed description and drawings of illustrative embodiments of the invention in which:

FIG. 1 is a front view of a tin-silver press-fit interconnect in accordance with the present invention; and

FIG. 2 is a sectional view of a PCB having the tin-silver press-fit interconnect installed therein in accordance with the present invention.

### DETAILED DESCRIPTION OF THE PREFERRED EMBODIMENTS

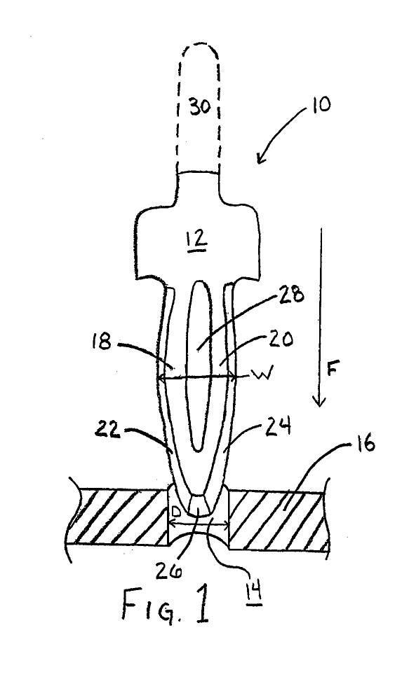

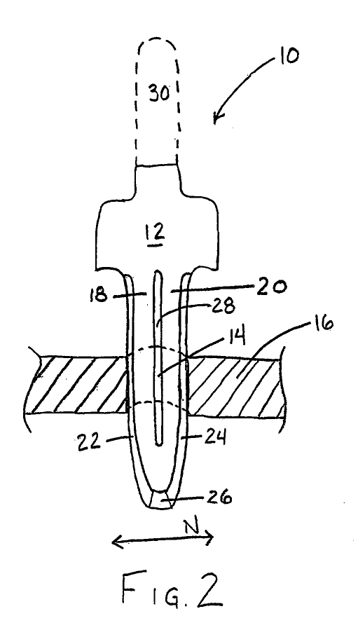

Referring to FIGS. 1 and 2, a press-fit interconnect, shown generally at 10 and which interfaces to an electrical component 30, is made up primarily of a terminal 12 which interfaces with a plated through-hole 14. In one embodiment, the terminal 12 includes right and left beams 18 and 20, having right and left outer edges 22 and 24, which merge at a tip 26. Between the right and left beams 18 and 20, is a needle-eye 28. The plated through-hole 14 is preferably a circular aperture through a PCB 16 having a diameter D which is less than the greatest width W of the terminal 12 measured between the outer peripheries of the right and left outer edges 22 and 24.

To assemble the press-fit interconnect 10 into a PCB 16, a force F is applied to the terminal 12 in order to press the tip 26 downwards into the plated through-hole 14. As the terminal 12 continues to be pressed downwards, the right and left beams 18 and 20 converge towards each another, thus narrowing the needle-eye 28 and creating a normal force N (see FIG. 2) caused by the right and left beams 18 and 20 pressing outwardly against the plated through-hole 14. The normal force N works to retain the terminal 12 in the plated through-hole 14. The resulting tin-silver interface provides a harder surface having a lower coefficient of friction such that there is less friction and lower assembly forces during assembly or insertion. Further, the tin-silver coating results in less fretting corrosion than pure tin. Fretting corrosion is a phenomenon which results from microscopic relative motion of interconnecting parts. As a result of these small movements, the oxides near the contact points can be broken up, with fresh material being exposed to the atmosphere, resulting in oxidized wear debris in the contact area, which ultimately leads to an increase in contact resistance.

The terminal 12 is made up of a base material, such as a copper-based alloy, and may have a barrier plate. If provided with barrier plating, the barrier plate is preferably nickel or copper provided over the base material at a thickness of 1 to 4 microns. Regardless of whether barrier plating is provided, the terminal 12 preferably has a top coating made up of a compound including primarily tin and an alternative doping agent, such as silver or bismuth.

In one embodiment, the terminal 12 has a top coating, or plating, of a tin-silver compound. The tin-silver coating can be applied by electroplating, hot dip or immersion. Preferably, the tin-silver compound is made up of between 85 and 99.5% weight of tin and between 0.5 and 15% weight of silver and is applied at a thickness range between 0.4 and 5 microns. The relative proportion of tin and silver may be modified to thereby modify the temperature characteristics, such as melt temperature, to suit particular applications, such as high temperature applications. Tin-silver coatings are described in U.S. Pat. Nos. 6,924,044 and 7,147,933, which are incorporated herein by reference. Other materials or doping agents, such as bismuth, silicon, magnesium, iron, manganese, zinc or antimony, may be added to the compound as desired to contribute properties, such as hardness, as required by a particular application. If one or more such additions are added to the compound, these additions will preferably make up less than 10% weight of the compound. The top coating can be applied to the entire terminal 12 or just portions thereof. For example, just the right and left beams 18 and 20 or the right and left outer edges 22 and 24 may be coated by a process such as brush electroplating. Preferably, both the terminal 12 and the plated through-hole 14 are provided with a coating of the tin-silver compound, though the plated through-hole may be plated with immersion silver or tin finishes.

The terminal 12 may be of a generally uniform thickness. For example, the profile of the terminal 12 may be formed or taken from a sheet of material by a process such as blanking or fine blanking. Alternatively, the right and left beams 18 and 20 may be formed such that the right and left outer edges 22 and 24 and/or the tip 26, decrease somewhat in thickness towards the outer periphery of the terminal 12. This may be done in order to conform better to the plated through-hole 14, to make the terminal 12 more compliant or to adjust the contact area and reduce forces as the terminal enters the PCB hole thereby avoiding hole deformation.

While the press-fit design shown in FIGS. 1 and 2 illustrates a two beam and a needle-eye design, other forms of press-fit, or compliant, terminals may be used. For example, the press-fit might utilize multiple two beam and needle-eye designs, or could use three or more beams. The needle-eye 28 also need not be elliptical, but may be any number of shapes such as square, rectangular, circular or D-shaped. Further, the needle-eye 28 could extend in one direction indefinitely such that the terminal 12 could take on C, V, Z or W type formations. Additionally, an interference fit could be formed by providing the terminal 12 and the plated through-hole 14 with differing and somewhat overlapping geometries, such as, for example square or rectangular pins for use with a round hole.

The press-fit interconnect 10 may be used in a variety of different industries, such as the automotive industry, for a number of different applications. The automotive industry in particular presents a number of challenges to electronics producers, as the environment is a high temperature one, often with heavy vibrations. A press-fit interconnect 10 in accordance with the present invention is suited to handle such conditions. By providing the terminal 12 with a tin-silver coating, the introduction of silver works to increase the melt temperature of the compound, thereby allowing the press-fit interconnect 10 to operate at higher temperatures and enjoy a longer, more predictable cycle life. Further, by varying the relative amounts of silver and tin in the compound, the melting temperature and other properties may be varied to fit the particular application.

Also important in the automotive industry are the insertion and retention forces associated with solderless components due to production, operating life and vibration concerns. In the automotive industry, plated through-holes 14 are typically provided with a diameter D of around 1.016 mm (0.040 inches) for signal pins (0.64 mm or 0.025 inches thick) and 1.486 mm (0.0585 inches) for power pins (0.81 mm or 0.031 inches thick). An example of a tin-silver terminal 12 that may be provided for a plated through-hole 14 corresponding to a signal pin and accounting for the tolerances associated with the production thereof would have a generally uniform thickness of around 0.64 mm (0.025″) and a maximum width W of around 1.2 mm (0.047″). The beam width and geometry, as well as the needle-eye width and geometry may be adjusted to match design specifications for insertion and retention forces based upon the integrity of the plated through-hole and the base and barrier plate materials used in the terminal 12. An example of a tin-silver terminal 12 that may be provided for a plated through-hole 14 corresponding to a power pin and accounting for the tolerances associated with the production thereof would have a generally uniform thickness of around 0.81 mm (0.031″) and a maximum width W of around 1.66 mm (0.065″). The beam width and geometry, as well as the needle-eye width and geometry may be adjusted to match design specifications for insertion and retention forces based upon the integrity of the plated through-hole and the base and barrier plate materials used in the terminal 12.

While the invention has been particularly shown and described with reference to preferred embodiments thereof, it will be understood by those skilled in the art that various changes in form and details may be made therein without departing from the spirit and scope of the invention.

We claim:

1. An electrical connector configured to connect to a substrate and mitigate whisker formation, the electrical connector comprising:
a solderless press-fit connector configured as a connector for mechanical and electrical connection to a substrate by insertion into a hole in the substrate; and
a layer of tin-silver material disposed on an outer surface of the press-fit connector, the layer of tin-silver material mitigating formation of whiskers extending from the connector.

2. The electrical connector of claim 1, wherein the solderless press-fit connector is an elongate terminal configured to be inserted into the substrate hole in a direction of the length of the terminal.

3. The electrical connector of claim 2, wherein the terminal is configured such that a maximum width of the terminal is larger than a diameter of the hole of the substrate.

4. The electrical connector of claim 2, wherein the terminal includes at least first and second beams merging at a tip disposed at an insertion end of the press-fit connector.

5. The electrical connector of claim 4, wherein the first and second beams are disposed on either side of a needle-eye, and wherein the first and second beams are configured to converge toward each other, narrowing the needle-eye, when the press-fit connector is inserted into the substrate hole, such that the first and second beams provide an outward force onto the substrate hole.

6. The electrical connector of claim 1, wherein the tin-silver material includes silver in a range of 0.5% to 15% by weight.

7. The electrical connector of claim 1, wherein the tin-silver material includes tin in a range of 85% to 99.5% by weight.

8. The electrical connector of claim 1, wherein the tin-silver material includes at least one of bismuth, silicon, magnesium, iron, manganese, zinc and antimony.

9. The electrical connector of claim 1, wherein the layer of tin-silver material has a thickness in a range of 0.5 to 4.0 microns.

10. The electrical connector of claim 3, wherein the maximum width of the terminal is in a range of between 1.2 and 1.66 mm.

11. A method of mitigating whisker formation during the connection of an electrical component and a terminal receiving device, the method comprising:
providing a terminal receiving device with a terminal receiving portion;
providing an electrical component with an electrical terminal configured for connection to the terminal receiving portion of the terminal receiving device;
disposing a layer of tin-silver material on an outer surface of the electrical terminal such that whisker formation in the terminal receiving device is mitigated; and
connecting the electrical terminal to the terminal receiving portion such that the whisker formation is mitigated when the electrical terminal is connected to the terminal receiving portion.

12. The method of mitigating whisker formation of claim 11, wherein the terminal receiving device is a substrate and the terminal receiving portion is a hole disposed in the substrate, wherein the electrical terminal is a solderless press-fit connector configured to be inserted into the substrate hole, and wherein whisker formation caused by the insertion of the solderless press-fit connector into the substrate hole is mitigated by the tin-silver material.

13. The method of mitigating whisker formation of claim 12, wherein the substrate hole is plated.

14. The method of mitigating whisker formation of claim 12, wherein the solderless press-fit connector is an elongate terminal configured to be inserted into the substrate hole in a direction of the length of the.

15. The method of mitigating whisker formation of claim 14, wherein the elongate terminal is configured such that a maximum width of the elongate terminal is larger than a diameter of the hole of the substrate.

16. The method of mitigating whisker formation of claim 14, wherein the elongate terminal includes at least first and second beams merging at a tip disposed at an insertion end of the press-fit connector.

17. The method of mitigating whisker formation of claim 16, wherein the first and second beams are disposed on either side of a needle-eye, and wherein the first and second beams are configured to converge toward each other, narrowing the needle-eye, when the press-fit connector is inserted into the substrate hole, such that the first and second beams provide an outward force onto the substrate hole.

18. The method of mitigating whisker formation of claim 11, wherein the tin-silver material includes silver in a range of 0.5% to 15% by weight.

19. The method of mitigating whisker formation of claim 11, wherein the tin-silver material includes tin in a range of 85% to 99.5% by weight.

20. The method of mitigating whisker formation of claim 11, wherein the tin-silver material includes at least one of bismuth, silicon, magnesium, iron, manganese, zinc and antimony.

21. The method of mitigating whisker formation of claim 11, wherein the layer of tin-silver material has a thickness in a range of 0.5 to 4.0 microns.
